(19) United States
(12) Patent Application Publication
(10) Pub. No.: US 2006/0215401 A1
(43) Pub. Date: Sep. 28, 2006

(54) Arrangement for the illumination of an image plane

(75) Inventors: Eva-Maria Menzel, Jena (DE); Arne Troellsch, Grossschwabhausen (DE); Artur Degen, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Jena GmbH

(21) Appl. No.: 11/388,664

(22) Filed: Mar. 24, 2006

(30) Foreign Application Priority Data
Mar. 26, 2005 (DE) 10 2005 013 950.7

(51) Int. Cl. F21V 1/00

(52) U.S. Cl. 362/235

(57) ABSTRACT

The invention is directed to an arrangement for the homogeneous illumination of an image plane, preferably for application in a head-up display in a motor vehicle, comprising illumination optics having an array of emitters with a broad emitting characteristic, for example, an arrangement of luminescent diodes (LEDs, OLEDs), an integrator array, and an image-generating element, and the optical axis of an emitter is associated with the mechanical axis of an integrator of the integrator array. According to the invention, at least two microlens arrays are provided for the purpose of achieving an angular homogeneity of the rays exiting from the integrator array on the illuminated area of the image-generating element at the light outlet of the integrator array.

### CROSS-REFERENCE TO RELATED APPLICATIONS

This application claims priority of German Application No. 10 2005 013 950.7, filed Mar. 26, 2005, the complete disclosure of which is hereby incorporated by reference.

### BACKGROUND OF THE INVENTION

a) Field of the Invention

The invention is directed to an arrangement for the homogeneous illumination of an image plane, preferably for application in a head-up display (HUD) in a motor vehicle, comprising illumination optics having an array of emitters with a broad emitting characteristic, for example, an arrangement of luminescent diodes (LEDs, OLEDs), an integrator array, and an image-generating element, and the optical axis of an emitter is associated with the mechanical axis of an integrator of the integrator array.

b) Description of the Related Art

Head-up displays are known and are increasingly offered as accessories in particular vehicle models. A virtual image of an object to be displayed is generated and, for example, is reflected into the windshield of the vehicle. To the observer, the image appears virtually in front of the vehicle on the road. Because of the optical imaging system that is required for this purpose, the observer can only discern the image when at least one of the observer's eyes is situated in the illuminated observation field. The image-generating elements are usually LCDs (liquid crystal displays) which require a very bright light source that can be dimmed in a dynamic range of 3000:1. Illumination sources of this kind are high-output luminescent diodes (LEDs) which are being used to an increasing extent.

In order to see a uniformly illuminated image in every position of the observation field, the light of the LEDs must be “shaped” in such a way that it illuminates the surface of the image-generating element as well as a defined angular area homogeneously.

Known arrangements comprise an array of hollow integrators. However, they have the disadvantage that neither the angular area nor the surface of the image-generating element is illuminated in a completely homogeneous manner. This is further complicated by the fact that hollow integrators are not particularly efficient because of the inner reflecting surfaces. Further, it is very difficult in terms of technique to coat hollow integrators having lengths over 10 mm from the inside. Yet, the requirement for homogeneous illumination of surfaces and angles necessarily leads to longer integrators.

An illumination arrangement of the kind mentioned above for image projection which comprises an illumination source array and an array of funnel-shaped hollow integrators is described, for example, in U.S. Pat. No. 6,318,863. The funnel shape of the hollow integrators has the advantage that the light radiation proceeding from the illumination source is distributed in a homogenized manner on a larger surface when the numerical aperture is reduced. This is important precisely when using light sources with relatively large radiating angles in order to avoid complicated, bulky collecting optics. In systems in which the light emergence angles vary in x-direction and y-direction and in which high efficiency is demanded, it is very complicated to achieve a homogeneous, well-defined angular distribution.

The disadvantage in the use of integrator arrays consists in the high manufacturing cost required to achieve a high positioning accuracy of the individual integrators, so that components of this type are very cost-intensive.

### OBJECT AND SUMMARY OF THE INVENTION

Proceeding from the above-described disadvantages of the prior art, it is the primary object of the invention to further develop an arrangement for the homogeneous illumination of an image plane in such a way that it is possible to improve the delimitation of the angular distribution at the light outlet and to improve the homogeneous illumination of the image plane by reducing technological costs with respect to the arrangement combined with a cost reduction for the illumination unit in its entirety.

This object is met, according to the invention, by an arrangement of the type described in the above in that at least two microlens arrays are provided for the purpose of achieving an angular homogeneity of the rays exiting from the integrator array on the illuminated area of the image-generating element at the light outlet of the integrator array, wherein the rays exiting from the integrator array impinge on the microlenses of the first microlens array.

The light proceeding from the illumination optics, that is, from the LED light sources, is initially collected by the associated integrators of the integrator array. Because of the multiple reflections in the integrators, the light components are homogenized when passing through the integrators, wherein only the light outlet surfaces are homogeneously illuminated. The areas of the radiating angles are homogenized through the subsequent arrangement of the microlens arrays in such a way that the light on the image-generating element uniformly illuminates a sharply delimited area, that is, in such a way that the angular distribution of the light after the microlens array is homogeneous in the aperture of the microlenses.

It is advantageous when two microlens arrays which are arranged one behind the other are characterized by identically constructed, regular arrangements of microlenses, which arrangements lie parallel to one another and in a mirror-inverted manner relative to one another, wherein the microlenses whose optical axes lie parallel to the optical axis of the illumination optics have raised functional surfaces.

In another conceivable constructional variant of the microlens arrays, the latter comprise two identically constructed arrangements of microlenses that are arranged one behind the other and the microlenses whose optical axes lie parallel to the optical axis of the illumination optics have raised functional surfaces which are oriented in the same direction.

For the purpose of an efficient field homogenization of the light exiting from the integrators, the distance between the microlens arrays that are arranged one behind the other should preferably be only ≦10 mm.

The paraxial focal length of the first microlens array should be in the vicinity of the output surface of the second microlens array. Since this focal length is rarely greater than 10 mm, the distance between the microlens arrays which are arranged one behind the other should preferably be only ≦10 mm.

An advantageous further development of the arrangement consists in that the two microlens arrays are made from one component (twofold microlens array). This reduces the quantity of individual elements and, therefore, also the assembly cost.

In order to achieve a high efficiency with respect to the homogeneous illumination of the image-generating element, the radii of curvature of the microlenses preferably deviate from one another by only ≦20%.

In another embodiment form, the microlenses are constructed so as to be cylindrical and rectangular, and the microlenses of the first array are arranged so as to be oriented at a 90-degree offset (crosswise) to the microlenses of the second array. In this way, the light is homogenized in the x-direction and y-direction. The substantial advantage of this variant consists in the reduced manufacturing cost as a result of less strict tolerances in the alignment and centering of the microlens arrays.

Further, it can be advisable to arrange the arrays in such a way that the microlenses of neighboring rows of microlenses are arranged so as to be displaced by one half of their length. This improves field homogeneities particularly in relatively large lenses.

The integrator array comprises identically constructed solid integrators or hollow integrators which are arranged directly next to one another and are produced from plastic or glass. It is better to use solid integrators because they can be produced more easily. It is disadvantageous that the structural lengths of solid integrators must be about 1.5-times larger than the structural lengths of hollow integrators.

The integrators are advantageously funnel-shaped and every light inlet surface is smaller than the light outlet surface. Every funnel-shaped integrator advisably comprises at least two step segments. The light outlet surface of a first step segment is adapted to the light inlet surface of a second step segment, and the angles between the reflecting beam guiding surfaces and the centering axes of the integrators of adjacent step segments are unequal.

As a result of the multiple-step arrangement of the integrators, virtually the totality of light proceeding from the illumination optics is transported to the light outlet surfaces when there is a change in the radiating angle. Through the dimensioning of the segments, which become progressively smaller from the light entrance surface to the light outlet surface, the respective light entrance angle and light emergence angle can be adapted in such a way that a homogeneous beam bundle that meets requirements with respect to the beam field and radiating angle occurs at the end of a multiple-step integrator.

The cross-sectional areas of the individual segments of the integrators are advantageously rectangular because these shapes bring about an exactly homogeneous field and a well-defined elliptic angular distribution. Up to 80 percent of the light entering an integrator reaches the required angular area (acceptance angle) so that the light drops off very sharply outside this acceptance angle.

It is also conceivable to obtain different efficiencies of the light transmission through different cross-sectional shapes between the light inlet surfaces and the light outlet surfaces of the segments of the integrators in order to adapt the intensity distribution in the field and in the radiating angle area to the illumination arrangement in accordance with requirements.

Also conceivable are arrays of the type mentioned above in which the inner segments of an integrator have different light inlet surfaces and light outlet surfaces (cross section) so that the lateral surfaces of an integrator are constructed in an irregular manner.

The inventive arrangement of the illumination optics in an array, a subsequent integrator array, and the lens arrangements having at least two arrays obviate the need for collecting optics for homogenization and intensity profiling, so that the arrangement is more economical and compact compared to the solutions of the prior art. Moreover, by adapting the illumination angles to the acceptance angles of the subsequent system, the efficiency of the system is increased and, by reducing stray light components, contrast is increased.

In an advantageous constructional variant of the arrangement using solid integrators made of plastic, the integrator array comprises at least two array portions which are manufactured by injection molding, each array portion having a base plate on which the integrators are shaped in multiple rows in such a way that they communicate with one another by the corners of their light outlet surface corners, while openings are provided between the integrators of an array portion for receiving the integrators of the second array portion.

The two array portions are produced by an injection molding process. Subsequently, by inserting one array portion into the other array portion, a closed integrator array is formed in which the individual integrators lie directly against one another by their walls.

The two-part arrangement of the arrays comprising solid integrators is a very economical variant, especially since a monolithic construction of an array in which the integrators contact one another directly could only be produced by a very costly manufacturing technique. This could not be realized by means of injection molding because an injection molding die must have a minimum wall thickness (distance between the integrators to be molded) of about 0.8 mm.

The arrangement according to the invention will be described more fully in the following by way of example with reference to the drawings.

### BRIEF DESCRIPTION OF THE DRAWINGS

In the drawings:

FIG. 1 is a schematic view of the arrangement according to the invention with two microlens arrays;

FIG. 2 is a schematic view of the arrangement according to the invention with a twofold microlens array;

FIG. 3 shows the radiating angle at the light outlet surface of an integrator;

FIG. 4 shows the acceptance angle at the light outlet of the microlens array;

FIG. 5 shows an embodiment form of a microlens array with uniformly arranged lenses;

FIG. 6 shows an embodiment form of a microlens array with lenses that are arranged so as to be offset;

FIG. 7 shows an embodiment form with two crossed microlens arrays;

FIG. 8 shows an embodiment form of an individual integrator;

FIG. 9 is a schematic view of a first array portion comprising solid integrators;

FIG. 10 is a schematic view of a second array portion comprising solid integrators;

FIG. 11 shows the positioning of the array portions according to FIGS. 7 and 8 before their assembly; and

FIG. 12 shows an assembly position of the two-part solid integrator array.

### DESCRIPTION OF THE PREFERRED EMBODIMENTS

FIG. 1 is a schematic view of the arrangement according to the invention with illumination optics 1 comprising an LED array, an integrator array 2, two microlens arrays 3 and 4, and an image-generating element 5.

The light emitted by the individual LEDs of the illumination optics 1 first reaches the associated integrators of the integrator array 2. Through the multiple reflections in the integrators, the light components are homogenized when passing through the integrator array 2 and the light outlet surfaces are illuminated homogeneously. Due to the arrangement of the microlens arrays 3 and 4 downstream, these microlens arrays 3 and 4 comprising two identically constructed, regular arrangements of identical lenses with raised surfaces, which arrangements are parallel to one another and mirror-inverted with respect to one another, the optical axes A1, A2, A3 and A4 of the lenses extending parallel to the optical axis AB of the illumination optics 1, the areas of the radiating angles α1 are homogenized in such a way that the light 6 on the image-generating element 5 uniformly illuminates a sharply delimited area 7.

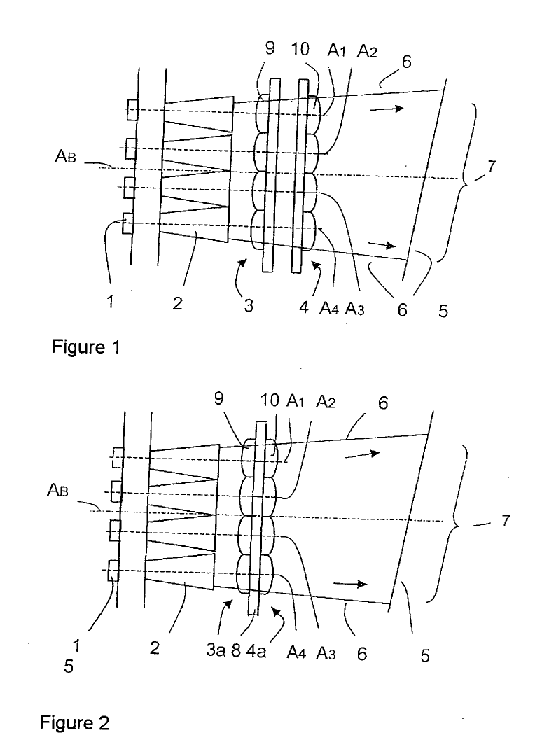

In a modification of FIG. 1, FIG. 2 shows an illumination arrangement in which only one component 8 with a twofold microlens array 3a and 4a is provided instead of the two microlens arrays 3 and 4 arranged one behind the other. The arrangement of the microlenses relative to one another was carried out analogous to the variant shown in FIG. 1. The advantage of this variant is that the quantity of individual elements and, therefore, the assembly cost is reduced.

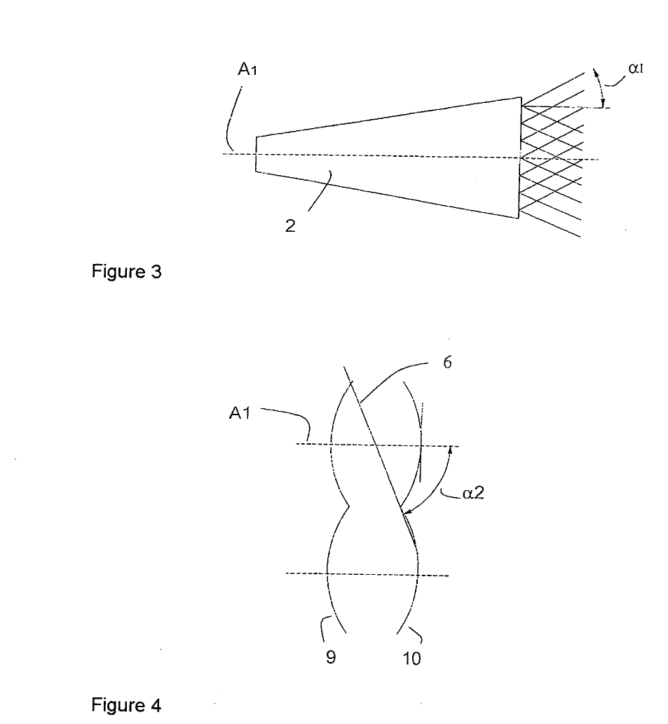

FIGS. 3 and 4 show the radiating angle α1 between the light flux 6 at the light outlet surface of an integrator and the optical axis A1 of the integrator (FIG. 3) and the acceptance angle α2 (FIG. 4) at the light outlet from the microlens array 4 between the light flux 6 and the optical axis A1 of a lens of the microlens array, where
α1=α2.

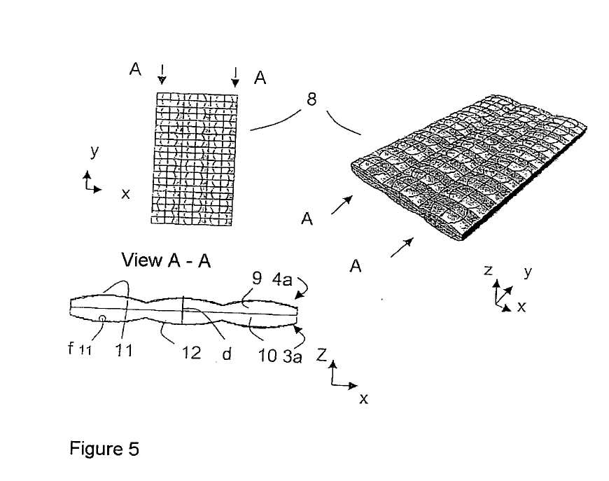

FIG. 5 shows the detailed embodiment form of a twofold microlens array 3a and 4a according to FIG. 2. This twofold microlens array 3a and 4a comprises two identically constructed, parallel and mirror-inverted regular arrangements of identical lenses 9 and 10 with raised surfaces 11 and 12 whose radii do not differ from one another by more than 20%. The focal points f11 of the raised surfaces 11 lie virtually on the oppositely located surface 12.

Two microlens arrays which are required for homogenization and are arranged one behind the other at the distance of the focal point f can be dispensed with through the construction of the surfaces 11 and 12, that is, due to the distances d between these surfaces 11 and 12. Only one component 8 with the twofold microlens array 3a and 4a is required. The absolute value of the distance d between the surfaces 10 and 111 of the microlenses 9 and 10 is defined by the equation
d=n·f,
where f is the focal length of the microlens in air and n is the index of refraction of the medium from which the microlens was produced.

The length L of a microlens 9 or 10 is given by the required maximum angle α of the light exit from the microlens array 3a or 4a (acceptance angle) and the focal length f according to the following equation:
L=2·f·tan α.

When using a microlens array 3a and 4a of the type mentioned above, the homogeneous light field which exits from the microlens array 4a facing the image-generating element 5 reaches the image-generating element 5 (see FIG. 1) at the defined angular distribution, a field point being associated with each lens of the microlens array 3a and 4a. When the microlenses 9 and 10 are very small, these field points can no longer be resolved, so that the illuminated surface 7 on the image-generating element 5, or the observation field, is homogeneously illuminated.

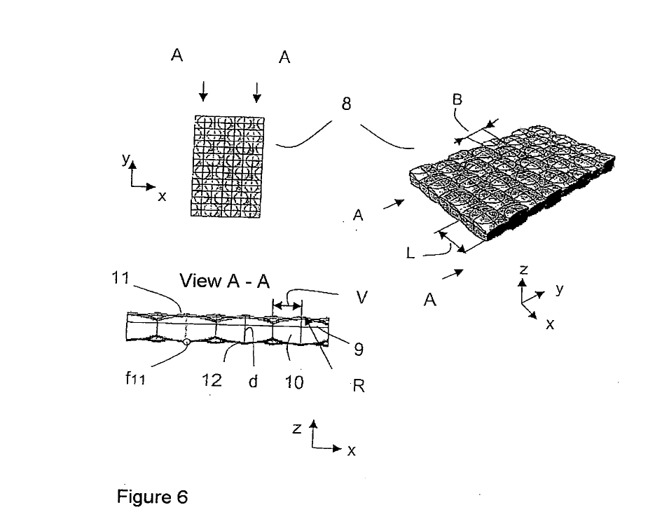

When cylindrical, rectangular lenses are used, for example, the areas in the x-direction and y-direction of the homogeneous illumination are different so that stripes can occur in a coordinate direction. In order to prevent this effect, the rows of microlenses lying next to one another on the microlens arrays are arranged so as to be offset relative to one another by one half of a microlens 9 or 10. An arrangement of this kind with an offset V is shown in FIG. 6. With rectangular microlenses, e.g., made of BK7, with the following dimensions:

length L=420 μm,

width B=320 μm,

radius of curvature R=0.98 mm,

an optimal illumination of the image-generating element 5 without stripes is generated at an offset V of the lenses of adjacent rows of 210 μm.

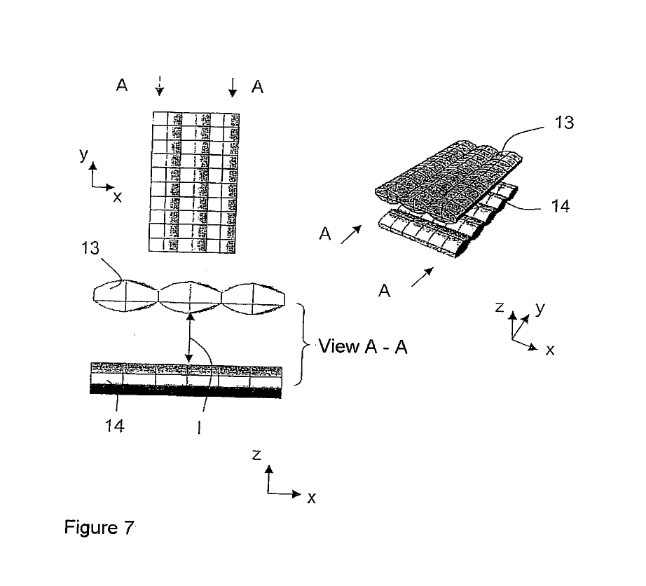

FIG. 7 shows an arrangement with two crossed microlens arrays 13 and 14 which can be applied when a rectangular observation field (eye box) is needed. In this connection, each of the microlens arrays 13 and 14 takes over the angle homogenization in the x-direction and y-direction. In order to achieve a good field homogenization, the distance 1 between the microlens arrays 13 and 14 should be ≦10 mm.

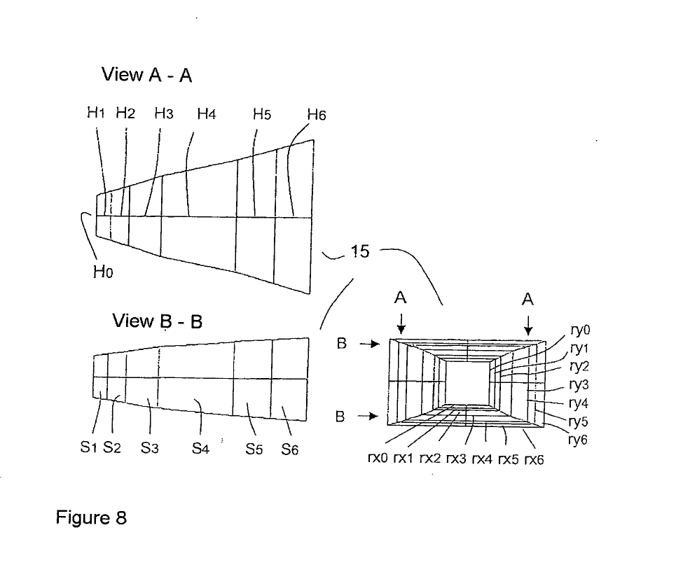

FIG. 8 shows an individual integrator 15 of an integrator array 2, according to FIGS. 1 and 2, which comprises six different, assembled segments S1, S2, S3, S4, S5 and S6 having rectangular cross sections. Segments S1, S2, S3, S4, S5 and S6 are shaped in such a way that the lateral surfaces are formed as plane surfaces and the light inlet surfaces are smaller than the light outlet surfaces. Every segment S1, S2, S3, S4, S5 and S6 is defined by the lengths H0 (light inlet), H1, H2, H3, H4, H5 and H4 and the semiaxes in the x-direction ry0, rx1, rx2, rx3, rx4, rx5 and rx6 and the semiaxes in the y-direction ry0, ry1, ry2, ry3, ry4, ry5 and ry4.

A homogenization efficiency of approximately 70.5% is achieved with the following parameters:

| | | Semiaxis | Semiaxis |
|---|---|---|---|
| | Length H0 to H6 | rx0 to rx6 | ry0 to ry6 |
| Segment | [mm] | [mm] | [mm] |
| Light inlet | 0.000 | 0.450 | 0.450 |
| S1 | 2.565 | 0.950 | 0.850 |
| S2 | 2.5625 | 1.248 | 1.050 |
| S3 | 5.125 | 1.800 | 1.440 |
| S4 | 10.250 | 2.400 | 1.890 |
| S5 | 10.250 | 2.900 | 2.230 |
| S6 | 10.250 | 3.300 | 2.500 |

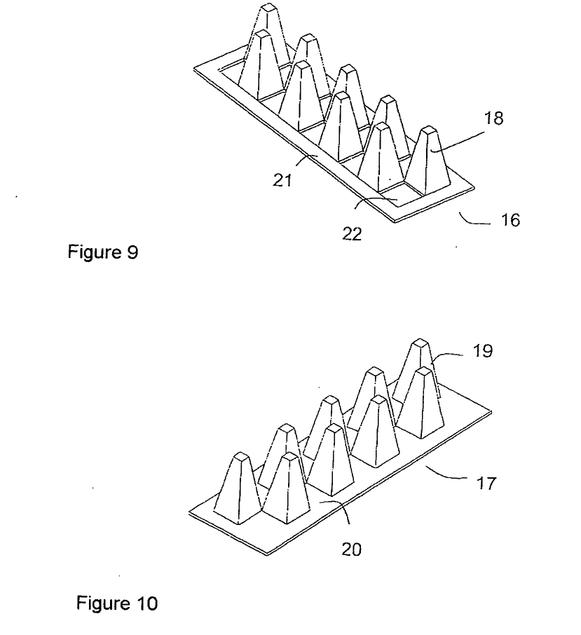

FIGS. 9, 10, 11 and 12 show the embodiment form of an arrangement of solid integrators 18 and 19 which comprises two array portions 16 and 17. Array portion 16 is shown in FIG. 9 and array portion 17 is shown in FIG. 10. The two array portions 16 and 17, which are produced from plastic by injection molding, have nine solid integrators 18 and 19 that are formed on the base plates 20 and 21. The base plate 21 of array portion 16 is constructed in such a way that there are openings 22 between the solid integrators 18. The openings 22 serve to receive the solid integrators 19 and are shaped and dimensioned in such a way that the solid integrators 19 of array portion 17 completely fill the openings 22 of array portion 16 in the assembled state of the array portions 16 and 17.

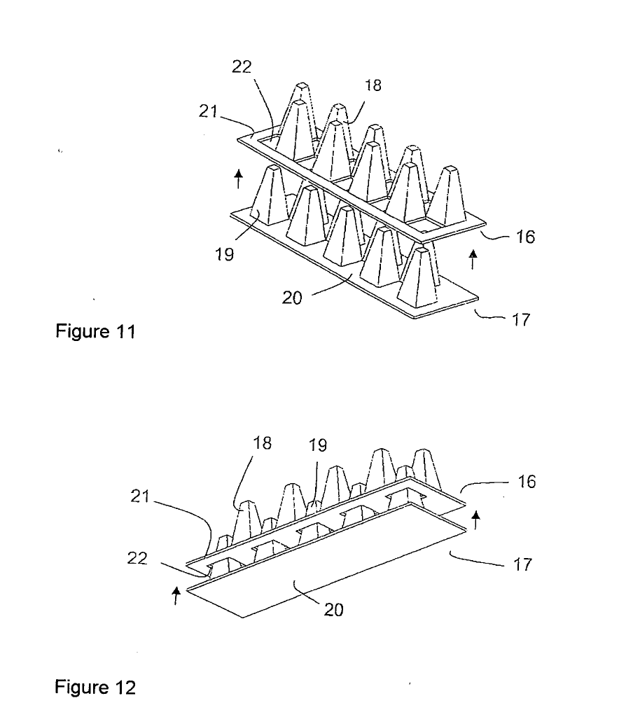

FIG. 11 shows the positioning of the array portions 16 and 17 before they are assembled, according to FIG. 12, to form the complete integrator array.

After the solid integrators 19 are fully inserted into the openings 22, that is, when the base plate 20 of array portion 17 contacts the base plate 21 of array portion 16, the integrator array, in which adjacent solid integrators 18 and 19 contact one another directly, is formed in a relatively simple manner.

While the foregoing description and drawings represent the present invention, it will be obvious to those skilled in the art that various changes may be made therein without departing from the true spirit and scope of the present invention.

### Reference Numbers

1 illumination optics (LED)
2 integrator array
3, 3a, 4, 4a, 13, 14 microlens array
5 image-generating element
6 light flux
7 image-generator area
8 optical element
9, 10 microlens
11, 12 raised surface
15 integrator
16, 17 individual element
18, 19 solid integrator
20, 21 base plate
22 opening
D, 1 distance
f focal point
α acceptance angle
A1-A4, AB optical axis
L lens length
B lens width
R radius of curvature
V offset
S1-S6 integrator segment
H0 light inlet
H1-H6 integrator segment length
X, Y coordinate direction
rx0-rx6 semiaxis, x-direction
ry0-ry6 semiaxis, y-direction
α1 radiating angle
α2 acceptance angle

What is claimed is:

1. An arrangement for the homogeneous illumination of an image plane, preferably for application in a head-up display in a motor vehicle, comprising:
illumination optics having an array of emitters with a broad emitting characteristic, such as an arrangement of luminescent diodes, an integrator array, and an image-generating element;
an optical axis of an emitter being associated with a mechanical axis of an integrator of the integrator array; and
at least two microlens arrays being provided for the purpose of achieving an angular homogeneity of the rays exiting from the integrator array on the illuminated area of the image-generating element at the light outlet of the integrator array.

2. The arrangement for the homogeneous illumination of an image plane according to claim 1, wherein two microlens arrays which are arranged one behind the other are characterized by identically constructed, regular arrangements of microlenses, which arrangements lie parallel to one another and in a mirror-inverted manner relative to one another, and the microlenses whose optical axes lie parallel to the optical axis of the illumination optics have raised functional surfaces.

3. The arrangement for the homogeneous illumination of an image plane according to claim 1, wherein two microlens arrays which are arranged one behind the other are characterized by identically constructed, regular arrangements of microlenses, which arrangements lie parallel to one another and in a mirror-inverted manner relative to one another, and the microlenses whose optical axes lie parallel to the optical axis of the illumination optics have raised functional surfaces that are oriented in same direction.

4. The arrangement for the homogeneous illumination of an image plane according to claim 1, wherein the distance between two microlens arrays is less than or equal to 10 mm.

5. The arrangement for the homogeneous illumination of an image plane according to claim 1, wherein the two microlens arrays comprise one component.

6. The arrangement for the homogeneous illumination of an image plane according to claim 1, wherein the radii of curvature of the microlenses of two microlens arrays arranged one behind the other deviate from one another by ≦20%.

7. The arrangement for the homogeneous illumination of an image plane according to claim 1, wherein the microlenses are constructed so as to be cylindrical and rectangular, and the microlenses of the first microlens array are arranged so as to be oriented at a 90-degree offset to the microlenses of the second microlens array.

8. The arrangement for the homogeneous illumination of an image plane according to claim 1, wherein the microlenses are constructed so as to be cylindrical and rectangular, and neighboring rows of microlenses are arranged so as to be offset relative to one another by one half of the length of a microlens.

9. The arrangement for the homogeneous illumination of an image plane according to claim 1, wherein the integrator array comprises identically constructed solid integrators or hollow integrators which are arranged directly next to one another and are produced from plastic or glass.

10. The arrangement for the homogeneous illumination of an image plane according to claim 1, wherein the integrators of the integrator array are funnel-shaped and every light inlet surface is smaller than the light outlet surface.

11. The arrangement for the homogeneous illumination of an image plane according to claim 10, wherein every funnel-shaped integrator comprises at least two step segments, and the light outlet surface of a first step segment is adapted to the light inlet surface of a second step segment, and the angles between the reflecting beam guiding surfaces and the centering axes of the integrators of adjacent step segments are unequal.

12. The arrangement for the homogeneous illumination of an image plane according to claim 8, wherein the cross-sectional areas of the integrators are rectangular.

13. The arrangement for the homogeneous illumination of an image plane according to claim 1, wherein the integrator array comprises at least two array portions which are manufactured by injection molding, each array portion having a base plate on which the integrators are shaped in multiple rows in such a way that they communicate with one another by the corners of their light outlet surface corners, while openings are provided between the integrators of an array portion for receiving the integrators of the second array portion.
